(19) United States
(12) Patent Application Publication
(10) Pub. No.: US 2013/0238880 A1
(43) Pub. Date: Sep. 12, 2013

(54) OPERATION PROCESSING DEVICE, MOBILE TERMINAL AND OPERATION PROCESSING METHOD

(71) Applicant: FUJITSU LIMITED, Kawasaki-shi (JP)

(72) Inventor: Masahiko TOICHI, Urayasu (JP)

(21) Appl. No.: 13/740,266

(22) Filed: Jan. 14, 2013

(30) Foreign Application Priority Data
Mar. 6, 2012 (JP) 2012-049301

(51) Int. Cl. G06F 9/30

(52) U.S. Cl. CPC G06F 9/3001
USPC 712/222

(57) ABSTRACT

An operation processing device for executing a plurality of operations for aligned data by one vector instruction includes a first mask storage unit and a second mask storage unit. The first mask storage unit stores first mask data to designate each of the plurality of operations a true or false operation, and the second mask storage unit stores second mask data to designate a number to be true continuously, in the plurality of operations.

### CROSS-REFERENCE TO RELATED APPLICATION

This application is based upon and claims the benefit of priority of the prior Japanese Patent Application No. 2012-049301, filed on Mar. 6, 2012, the entire contents of which are incorporated herein by reference.

### FIELD

The embodiments discussed herein are related to an operation processing device, a mobile terminal and an operation processing method.

### BACKGROUND

Conventionally, a vector processor has been used as an operation processing device (processor) that is capable of processing calculations (vector operations) for aligned data by one instruction. There is a plan to apply a vector processor of this kind to software-defined radio (SDR) for mobile terminals, in addition to scientific technical calculations such as weather forecast and fluid analysis.

A vector processor is able to achieve high operation throughput by continuously loading data in a plurality of operators, and adopts various mechanisms to increase the number of data which may be processed in one cycle.

Now, for efficient processing in a vector processor, it is preferable to increase the number of data (vector length: VL) to operate by one vector instruction and process more data by one instruction.

Meanwhile, when the number of data to process exceeds the VL setting range that may be designated by the vector processor, the data may be processed separately in a plurality of times. When the number of data is not a square of two, the fraction is set. As for the method of setting the fraction, there are the following three methods. To illustrate each method, assume that the number of data to process is 100.

The first method adjusts the VL in the final round (second cycle), and, after processing at VL=64, changes the VL (VL=36) and performs the processing. The first method has a problem of incurring cycle cost to rewrite the VL. Note that the simplest method of rewriting the VL may be to do the rewriting when there is no execution instruction.

The second method selects an equivalent VL, and, after processing at VL=50, performs the processing at the same VL of 50. In other words, the first cycle and second cycle are both processed at VL=50. The second method has a problem of having to perform processing for finding out an optimal number of repetitions (equivalent VL) when the length of data changes dynamically.

The third method applies adjustment by means of a mask register in the final round (second cycle), and, after processing at VL=64, performs the processing at VL=64, and, in the processing of the final round, makes [0 . . . 35] true and makes [36 . . . 63] false, by the mask register.

To implement the third method, for example, a mask instruction to designate that [0 . . . 35] are true and [36 . . . 63] are false, may be provided newly in the mask register.

Furthermore, according to the third method, a bit pattern of 64 bits to correspond to the VL is stored on a memory, and processing to load this may be performed, and therefore even the data part that is not to be processed (that is false) requires a cycle.

As described above, when the number of data to process exceeds the VL setting range which may be designated by a vector processor, or when the number of data to process changes variously, it is difficult to perform the processing of the vector processor efficiently. In other words, there is a problem that it is difficult to process data efficiently even when the number of data exceeds the VL setting range which may be designated by the vector processor.

In this regard, in the past, various types of vector processors (operation processing devices) have been proposed.
Patent Document 1: Japanese Laid-open Patent Publication No. S57-027364
Patent Document 2: Japanese Laid-open Patent Publication No. S57-027360

### SUMMARY

According to an aspect of the embodiments, there is provided an operation processing device for executing a plurality of operations for aligned data by one vector instruction. The operation processing device includes a first mask storage unit and a second mask storage unit.

The first mask storage unit stores first mask data to designate each of the plurality of operations a true or false operation, and the second mask storage unit stores second mask data to designate a number to be true continuously, in the plurality of operations.

The object and advantages of the embodiments will be realized and attained by the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a timing chart for illustrating how a plurality of instructions are executed in an example of an operation processing device;

FIG. 2 is a diagram for illustrating a mask register in an operation processing device;

FIG. 3 is a diagram for illustrating the functions of a mask register;

FIG. 4 is a block diagram illustrating an example of an operation processing device to which the present embodiment is applied;

FIG. 5 is a diagram for illustrating a scalar register in the operation processing device of FIG. 4;

FIG. 6 is a diagram for illustrating a vector register in the operation processing device of FIG. 4;

FIG. 7A and FIG. 7B are diagrams for each illustrating an implementation example of a mask register in the operation processing device of FIG. 4;

FIG. 8 is a diagram for illustrating a reading operation in the operation processing device of the present embodiment;

FIG. 9 is a block diagram illustrating an example of a mask register in the operation processing device of the present embodiment;

FIG. 10 is a diagram for illustrating the addresses and data arrangement in the mask register of FIG. 9;

FIG. 11 is a diagram for illustrating processing of a converter in the mask register of FIG. 9;

FIG. 12 is a timing chart for illustrating an example of operations in a bit pattern mask mode in the operation processing device of the present embodiment;

FIG. 13 is a timing chart for illustrating an example of operations in an integer mask mode in the operation processing device of the present embodiment;

FIG. 14 is a diagram illustrating an example of data entries in a bit pattern mask mode and in an integer mask mode;

FIG. 15 is a diagram for illustrating mask register writing by a vector instruction in the operation processing device of the present embodiment;

FIG. 16 is a diagram for illustrating mask register writing by a scalar instruction in the operation processing device of the present embodiment;

FIG. 17 is a diagram for illustrating instruction issue control in the operation processing device of the present embodiment (pattern 1);

FIG. 18 is a diagram for illustrating instruction issue control in the operation processing device of the present embodiment (pattern 2);

FIG. 19A and FIG. 19B are diagrams for each illustrating another implementation example of a mask register in the operation processing device of the present embodiment;

FIG. 20 is a diagram for illustrating a modification example of integer mask data in the operation processing device of the present embodiment;

FIG. 21 is a diagram schematically illustrating an example of the mobile terminal of the present embodiment;

FIG. 22 is a block diagram illustrating an example of a baseband processing unit in the mobile terminal of the present embodiment;

FIG. 23 is a diagram for illustrating an example of software-defined radio functions to perform communication by switching between different communication schemes by the mobile terminal of the present embodiment; and

FIG. 24 is a flowchart illustrating an example of processing to realize the software-defined radio functions of FIG. 23.

### DESCRIPTION OF EMBODIMENTS

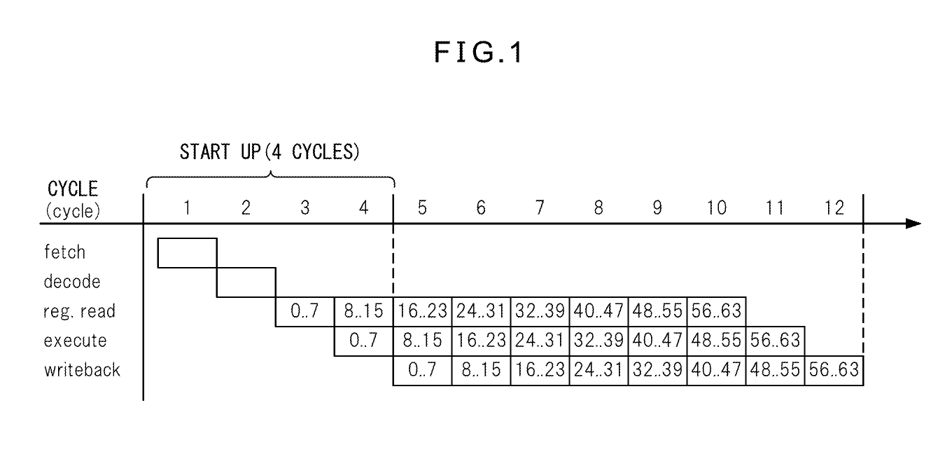

First, before explaining embodiments of the operation processing device, the mobile terminal and the operation processing method of the present embodiment, execution of instructions in an example of the operation processing device, and a mask register, will be illustrated with reference to FIG. 1 to FIG. 3. FIG. 1 is a timing chart for illustrating how a plurality of instructions are executed in an example of the operation processing device.

In FIG. 1, the operation processing device (vector processor) is a processor which is capable of processing vector operations for aligned data by one instruction, and which is designed to achieve high operation throughput by continuously loading data in the operators.

Furthermore, the vector processor has a plurality of operators which may operate in parallel, and is designed to process in a cycle of [startup (latency)+the number of data/the number of operators], for continuous aligned data. Furthermore, further improvement of performance is made possible by providing a plurality of vector pipelines which may operate at the same time, and executing instructions in parallel.

For example, when a vector processor to include eight 16-bit operators performs operation for aligned data with sixty four elements, and when the startup is made four cycles, it is possible to finish the operations in 4+64/8=12 cycles. Note that the startup corresponds to the time (cycles) until data flows in all pipelines.

Note that each operator performs five processes, including, for example, fetching of an instruction (“fetch”), decoding (“decode”), reading from a register (“reg. read”), execution (“execute”) and writeback (“writeback”).

Note that “0 . . . 7,” “8 . . . 15,” . . . , and “56 . . . 63” in the blocks of FIG. 1 indicate the eight elements of data to be processed in each operator per cycle, in aligned data “0 . . . 63” of sixty four elements.

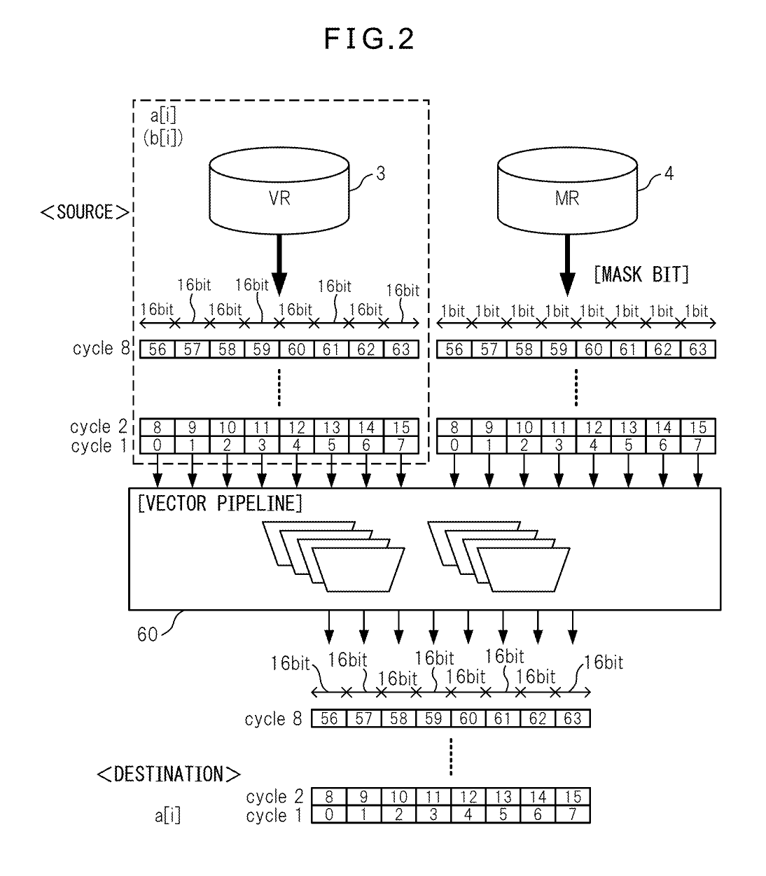

FIG. 2 is a diagram for illustrating a mask register in the operation processing device, and illustrates an example of processing in one vector pipeline.

First, the vector length and the mask register will be illustrated. First, the number of data to be operated by one vector instruction will be referred to as the vector length (VL). As for the VL, generally, the value is stored in a control register and/or the like, and vector instructions operate with reference to the control register. Note that the maximum value of the VL which may be designated is determined by, for example, the limit of circuit resources of the operation processing device (vector processor).

Furthermore, a register to designate operations true (T) or false (F) will be referred to as a mask register (MR). When a vector instruction is executed, MRs to match the VL are read, and when the corresponding MR is true (T), the operation is performed, and, when the corresponding MR is false (F), the operation result is made false.

Note that, as a simple implementation, it is possible to use the MR (the setting value of the MR) as a write enable (WE) signal for a destination (data storage destination) register. In other words, when the MR is true, operation result data is written in the destination register, and, when the MR is false, operation result data is controlled not to be written in the destination register.

A vector instruction is applicable to processing using a loop, and, when mask register functions are provided, the vector instruction is applicable even when there is a conditional branch in the loop.

To be more specific, a case will be considered here where alignments of a[i] and b[i] are added and stored in a[i]. Note that when a negative value is given, the value to store in a[i] is replaced by “0.” Although, in FIG. 2, only a vector register (VR) 3 to read a[i] (a[0 . . . 63]) and a mask register (MR) 4 are illustrated as sources, the VR to read b[i] (b[0 . . . 63]) is the same as the VR to read a[i] and is omitted in FIG. 2.

Furthermore, in the example of FIG. 2, the vector pipeline 60 includes eight 16-bit operators, and processes eight 16-bit operations in parallel per cycle. In other words, when VL=64, in the actual circuits, placing sixty-four 16-bit operators in the width direction results in an increased footprint and poses difficulty (due to a disadvantageous area). Consequently, for example, by processing eight 16-bit operators over eight cycles, an operation instruction of VL=64 is executed and the footprint is made small.

Original algorithm:

for(i=0; i<64; i++){

a[i] = a[i] + b[i];
if(a[i] < 0) a[i] = 0;

}

An example of replacement a by vector instruction (summary of the operations of the instruction):

| | |
|---|---|
| vload sr1 vr1 | (aligned data is read to vr1) |
| vload sr2 vr2 | (aligned data is read to vr2 |

| | |
|---|---|
| vadd vr1 vr1 vr2 | (vr1 + vr2 −> vr1) |

| | |
|---|---|
| vcmp mr3 vr1 #0 | (if(vr1[i] < 0 ) mr3[i] = true ; else |

mr3[i] = false)

| | |
|---|---|
| vset vr1 #0 mr3 | (if(mr3[i] = true) vr1[i] = 0; else |

vr1[i] = vr1[i])

| | |
|---|---|
| vstore sr1 vr1 | (vr1 is written back in the memory) |

When the result (operation result) of adding the alignments of a[i] and b[i] is stored in a[i], which is the destination (data storage destination), writing is controlled by the mask bit values, provided per one bit, corresponding to each element (data). To be more specific, writing is controlled such that, when a mask bit is “1,” operation result data is made true and written, and, when a mask bit is “0,” operation result data is made false and not written. Note that the mask bit is not limited to one bit, and may be two bits or more to add other functions.

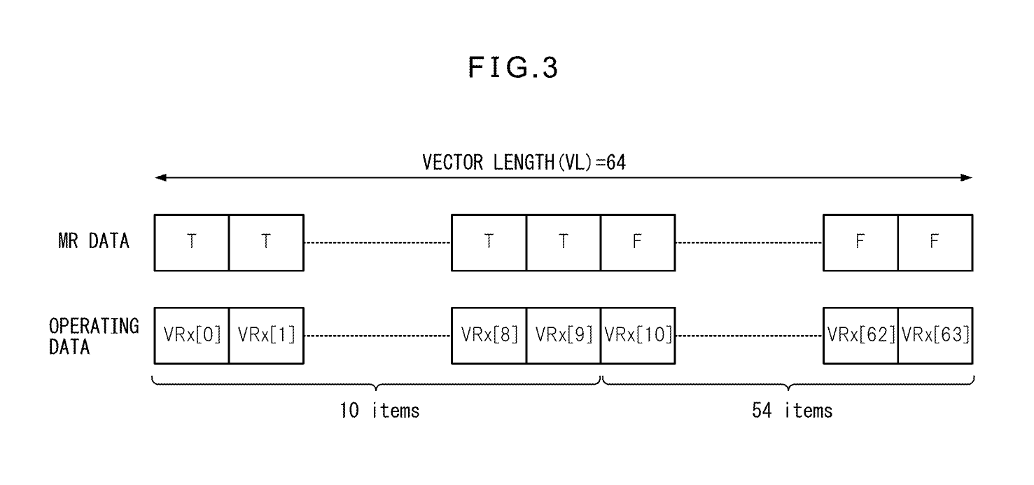

FIG. 3 is a diagram for illustrating the functions of the mask register. As illustrated in FIG. 3, there are times where a mask register is used to change the number of operating data without changing the VL. In other words, as illustrated in FIG. 3, by using a mask register in which the first ten are T (true) and the remaining fifty four are F (false), it is possible to perform ten operations.

Then, by preparing such a mask register in advance, it is possible to execute a vector instruction without overhead to rewrite the VL. However, since the later F part requires predetermined cycles, there are cases where rewriting the vector length allows faster operations.

When the number of data is greater than the maximum value of the VL, although the processing may be performed by executing an instruction a plurality of times, when an adequate number of times is selected then, the fraction will be processed in the final round.

For example, when VL=64 and the number of data items is 250, 250=64+64+64+58 is given, and therefore only fifty eight pieces of data are processed in the final round (fourth cycle). In particular, in the field where an operation processing device is used for embedded use, for example, the VL is short compared to a super-computer, and therefore the influence of processing the fraction (overhead to change the number of data, change of the VL, setting of mask) increases.

Now, when performing vector operations for various numbers of data (data lengths), for example, two patterns of changing the VL (vector length) and designating the mask register are possible. The data of the mask register (bit pattern mask data) carries data as to whether the bits corresponding to the VL are T (true) or F (false).

The setting is difficult to perform in one cycle and therefore may be done over a plurality of cycles. In other words, only writing of operation results and writing of data read from the memory are performed.

First, when changing the VL (the above-described first and second methods), the cycle cost to rewrite the VL is required, and, when the data length changes dynamically, the processing to find out an optimal number of repetitions may be performed, which results in decreased efficiency of processing.

Furthermore, when designating the mask register, continuous data is not always formed such that true data continues in the first half and false data continues in the second half. Consequently, when the fraction is processed using bit pattern mask data without changing the VL, a predetermined number of times of processing may be repeated even when only false operations are performed. In other words, by performing false operations alone, the efficiency of processing decreases.

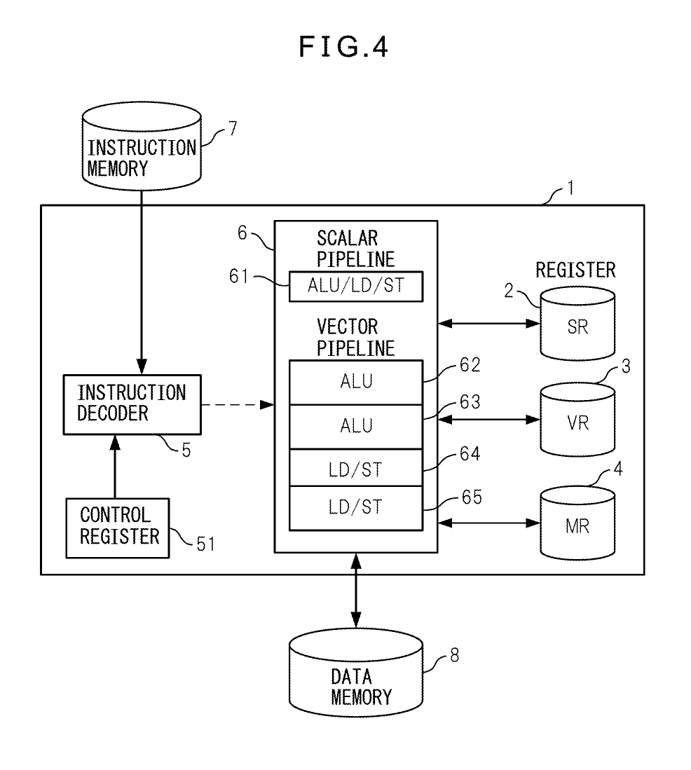

Hereinafter, embodiments of the operation processing device, the mobile terminal and the operation processing method will be described below in detail with reference to the accompanying drawings. FIG. 4 is a block diagram illustrating an example of an operation processing device to which the present embodiment is applied. In FIG. 4, the reference code 1 designates the operation processing device (vector processor), 2 designates a scalar register (SR), 3 designates a vector register (VR), and 4 designates a mask register (MR).

In addition, the reference code 5 designates an instruction decoder, 51 designates a control register, 6 designates a pipeline operation unit, 7 designates an instruction memory, and 8 designates a data memory.

As illustrated in FIG. 4, a vector processor 1 includes the instruction decoder (decode logic) 5, the pipeline operation unit 6, the scalar register 2, the vector register 3 and the mask register 4. The pipeline operation unit 6 includes one scalar pipeline 61 and four vector pipelines 62 to 65.

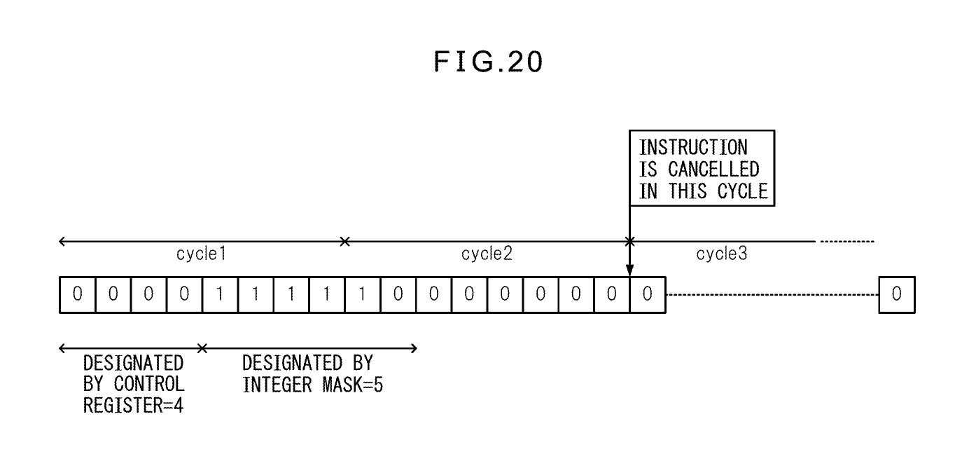

Note that, as described above, although the control register 51 holds values such as the vector length (VL) and/or the like, for example, as will be described later with reference to FIG. 20, when continuous data (operations) that is true does not start from the top of the VL, the control register is used also to designate the starting position of the true continuous data.

The vector register 3 and the mask register 4 are registers for vector operations, and the scalar register 2 is a register for scalar operations. The vector pipelines 62 to 65 are each able to perform data operations for the vector length (VL) for the vector register 3, which will be described later.

The vector pipelines 62 and 63 execute vector processing of operation instructions such as ALU, multiplication and logical operations, and, furthermore, the vector pipelines 64 and 65 execute vector processing of transfer instructions such as load/store (LD/ST).

Note that the vector processor 1 illustrated in FIG. 4 also includes one scalar pipeline 61, and, by means of the scalar pipeline 61, is able to calculate one piece of data of the scalar register 2. In other words, the scalar pipeline 61 executes scalar processing of instructions such as ALU, LD and ST. As illustrated in FIG. 2 described above, the vector pipelines 62 to 65 (60) each include, for example, eight 16-bit operators, and are each designed to be able to operate eight 16-bit operations in parallel per cycle.

Note that the data memory 8 includes, for example, four banks (memory blocks), and is connected to the scalar pipeline 61 and the vector pipelines 62 to 65 via a multiplexer/demultiplexer (not illustrated).

In the present specification, not only the register to store bit pattern mask data which designates T/F of operations, but also, as will be described later, the register to store integer mask data and the register to store modes will also be referred to as the mask register MR (mask register unit). In addition, assume that the mask register unit further includes a converter to convert integer mask data into bit pattern mask data, a selector and/or the like.

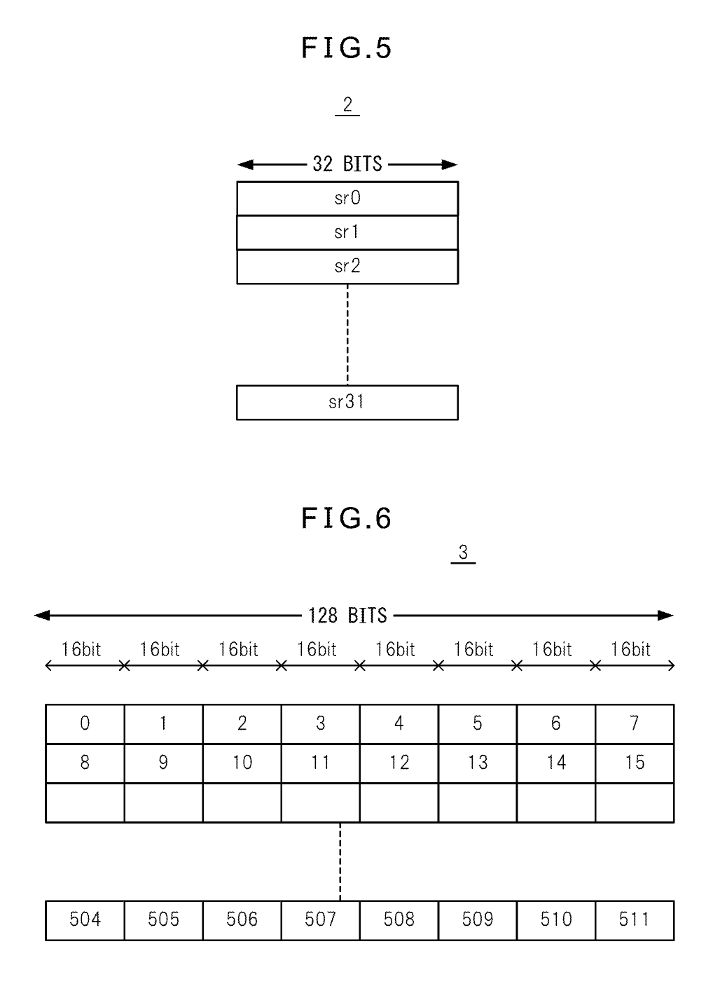

FIG. 5 is a diagram for illustrating the scalar register in the operation processing device of FIG. 4. As illustrated in FIG. 5, the scalar register (SR) 2 is, for example, a register of a 32-bit width, and stores data such as addresses.

FIG. 6 is a diagram for illustrating the vector register in the operation processing device of FIG. 4. As illustrated in FIG. 6, the vector register (VR) 3 is, for example, a register of a 128-bit width, and stores eight pieces of 16-bit data for each entry.

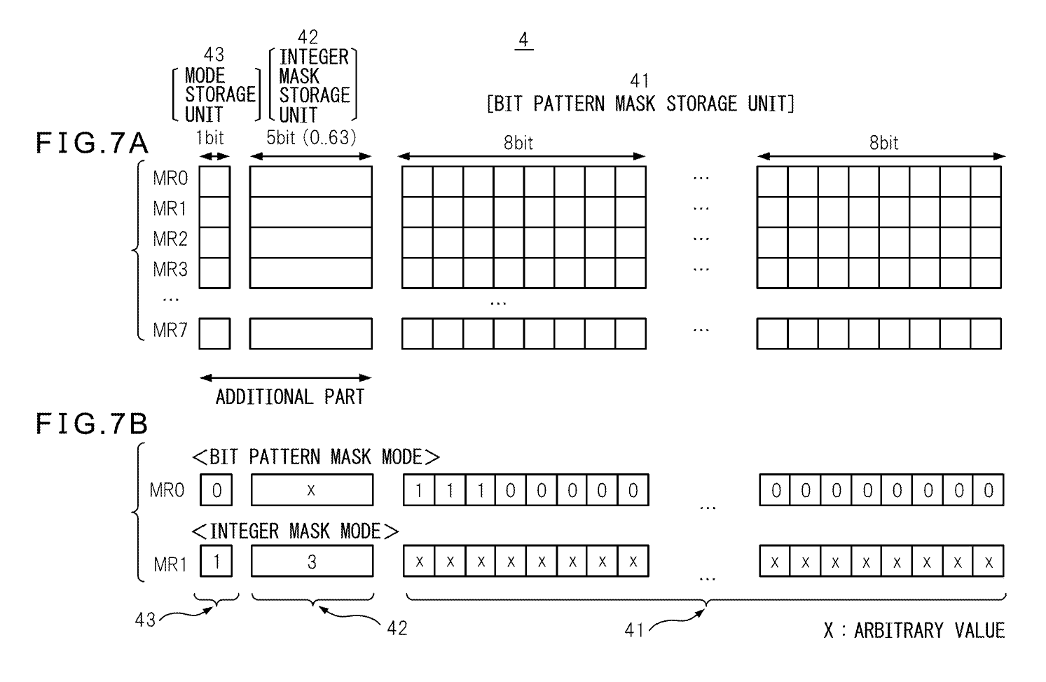

FIG. 7A and FIG. 7B are diagrams for each illustrating an implementation example of the mask register in the operation processing device of FIG. 4, where FIG. 7A illustrates a configuration of the mask register (unit) 4 and FIG. 7B illustrates an example of a bit pattern mask mode and an integer mask mode.

The bit pattern mask mode is a mode in which, in the vector operation processing device to execute a plurality of operations for aligned data by one vector instruction, the plurality of operations are each designated a true or false operation in bit units.

Furthermore, the integer mask mode refers to a mode to designate, by an integer, the number to be true continuously, in the plurality of operations (for example, the number to be true continuously from the top). Note that the vector operation processing device (vector processor) includes, for example, a scalar pipeline (61) and vector pipelines (62 to 65), as has been described with reference to FIG. 4.

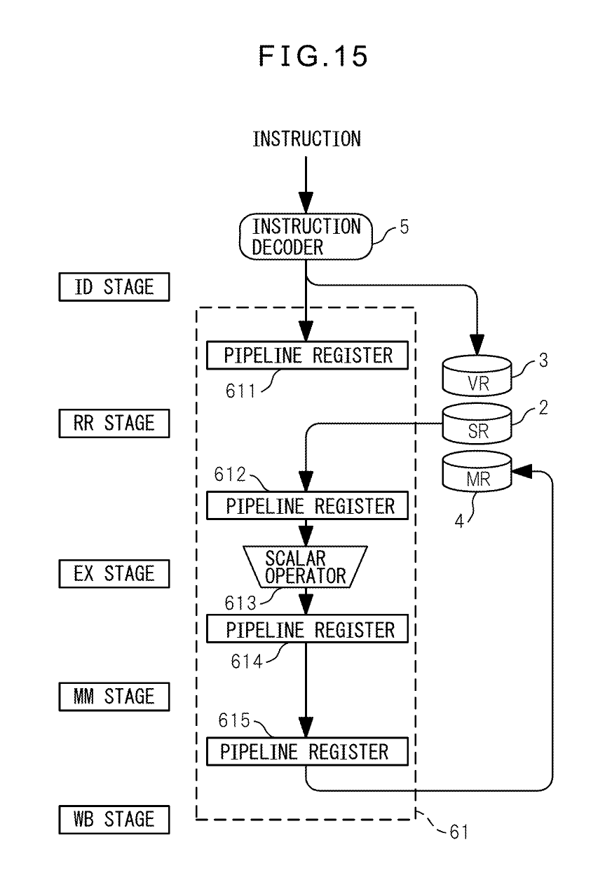

Furthermore, as will be described later in detail with reference to FIG. 15, with an instruction that is a scalar instruction and that makes the mask register MR the destination, the writing may be executed by placing the MR in the integer mask mode.

As illustrated in FIG. 7A, the mask register 4 includes a bit pattern mask storage unit 41 that has an 8-bit width and that stores 512 bits of bit data, an integer mask storage unit 42 of a 5-bit width, and a mode storage unit 43 of a 1-bit width, as data entries.

Although the bit pattern mask storage unit 41 is provided in a mask register of a general vector processor, the integer mask storage unit 42 and the mode storage unit 43 are added newly in the mask register of the present implementation example.

Note that, with the present embodiment, by providing the integer mask storage unit 42 and the mode storage unit 43 with the bit pattern mask storage unit 41, it is possible to perform vector processing efficiently using the integer mask mode.

In other words, compared to a vector processor having only a function for designating true and false operations in a plurality of operations in bit units, the present embodiment is able to use an integer mask mode function for designating the number to be true continuously.

By means of the integer mask mode (integer mask storage unit), it is possible to learn in advance the number of operations to be true continuously, so that it is possible to make operations unnecessary for the subsequent false part, and, by this means, it is possible to reduce unnecessary operations and perform vector processing efficiently.

In the implementation examples illustrated in FIG. 7A and FIG. 7B, up to eight MR registers (MR0 to MR7) may be designated as operands, and eight bit pattern mask storage units 41, integer mask storage units 42 and mode storage units 43 are included.

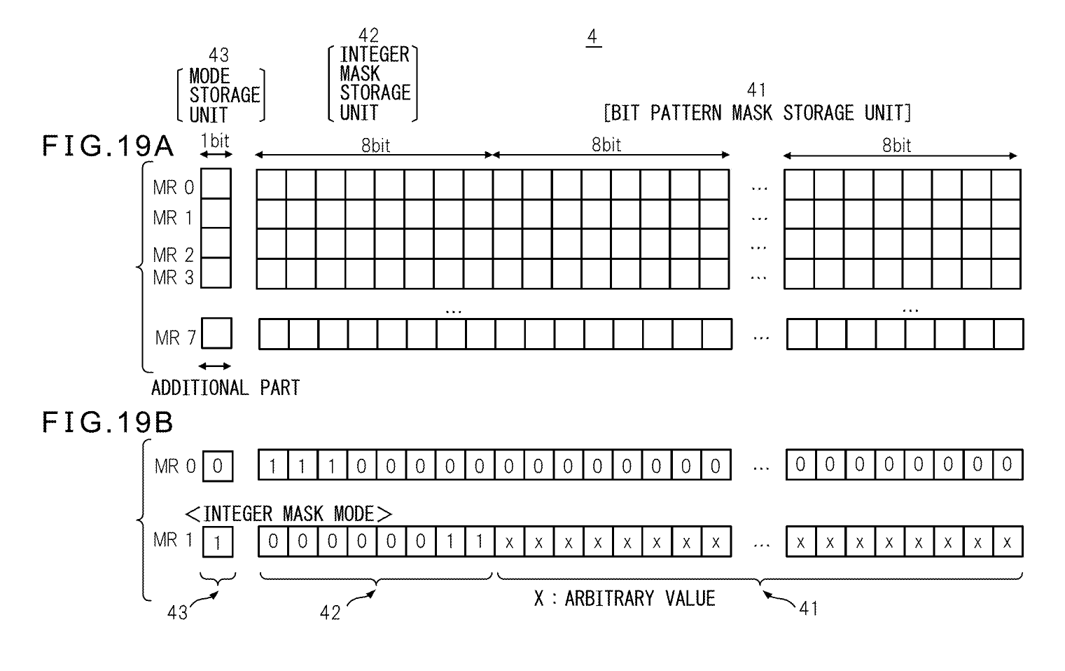

As will be described later in detail with reference to FIG. 19A and FIG. 19B, as in FIG. 7A and FIG. 7B, it is possible to use (share) a register entry of a general vector processor as the integer mask storage unit 42, without adding the integer mask storage unit 42 and the mode storage unit 43 as new registers.

FIG. 7B illustrates examples of a bit pattern mask mode in which the value (flag) of the mode storage unit 43 is “0” and an integer mask mode in which the value of the mode storage unit 43 is “1,” both representing cases where the first three pieces of data from the top are true (T) and the subsequent data is all false (F).

First, in MR0 in which the value of the mode storage unit 43 is “0” and which is in the bit pattern mask mode, a bit pattern in which the first three bits are “1, 1, 1” and all the subsequent bits are “0, 0, . . . , 0,” is stored in the bit pattern mask storage unit 41.

Note that, in the bit pattern mask mode, the value of the integer mask storage unit 42 may be an arbitrary value (x). Furthermore, in a bit pattern mask mode, since bits to indicate true/false are assigned to all data (elements), the data to be true does not necessarily continue.

Next, in MR1 in which the value of the mode storage unit 43 is “1” and which is in the integer mask mode, the integer value “3” is stored in the integer mask storage unit 42. Note that, in the integer mask mode, all the bits in the bit pattern mask storage unit 41 may be arbitrary values (x).

The integer value (integer data) to be stored in the integer mask storage unit 42 indicates the number of data to be true (T) continuously from the top, and, once false (F) appears, it is known that the rest is all false, and it is not needed to execute the subsequent operations.

Consequently, when false appears, instructions up to then are cancelled, and by releasing the pipeline resources and executing the subsequent instructions, it is possible to accelerate (make efficient) the processing.

In this way, with the present embodiment, the mode storage unit 43 to set the integer mask mode or the bit pattern mask mode and the integer mask storage unit 42 to store an integer value to indicate the number of continuous data (operations) to be true from the top, are newly added to the mask register 4.

The mode storage unit 43 may be one bit per MR, and, furthermore, assuming that the maximum value of the vector length (VL) is VLM, the integer mask storage unit 42 may be Log₂ (VLM) bits (for example, when VLM=32 and a 5-bit width), and therefore the increase of registers is not much of a problem.

In other words, when VLM is about this big (even when VLM is approximately 1024), a move from another register and a set from an immediate value may be executed in one cycle.

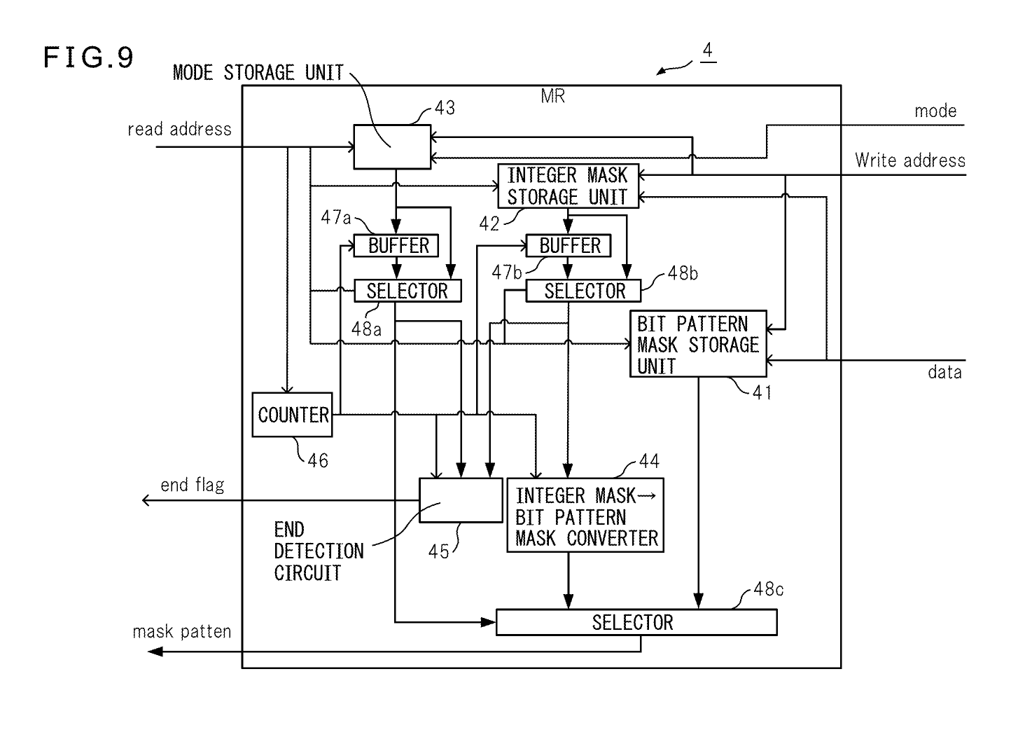

Note that, providing a converter (44) that converts the integer value stored in the integer mask storage unit 42 into bit data and supplies the bit data to the pipelines allows the user (programmer) the same use as a normal vector processor. In other words, since the programmer is unable to see the registers such as the integer mask storage unit 42 and the mode storage unit 43, the user is allowed use without care. This will be described later in detail with reference to FIG. 9.

Furthermore, in the integer mask mode, for example, although the number of continuous data that is true from the top (the number of operation result data) is stored in the integer mask storage unit 42, as will be described later in detail with reference to FIG. 20, true data may continue even when the data does not necessarily continue from the top.

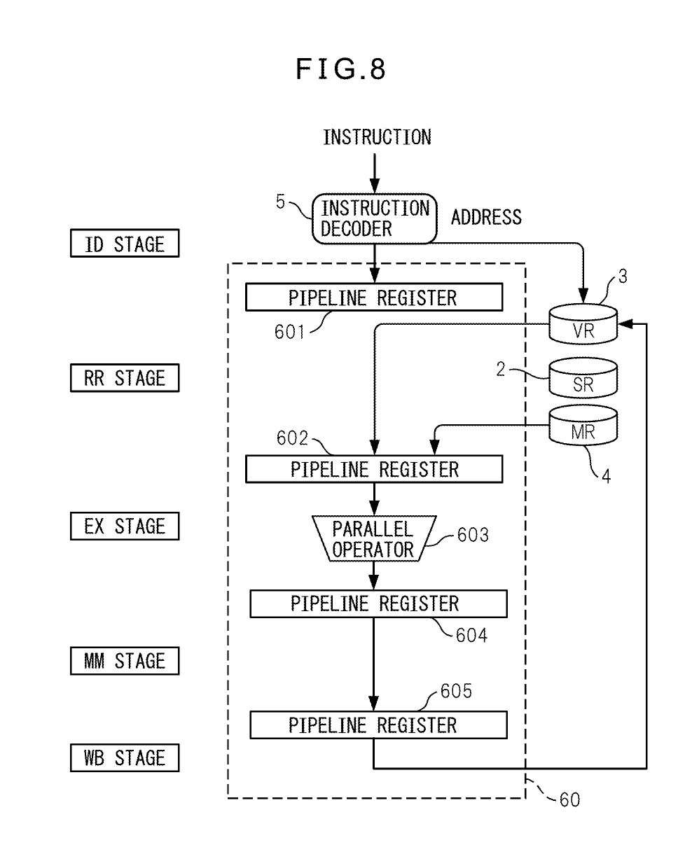

FIG. 8 is a diagram for illustrating the reading operation in the operation processing device of the present embodiment, and, using the vector register 3 and the mask register 4 as sources, illustrates the operations of a vector instructions making the vector register 3 be the destination.

As illustrated in FIG. 8, the vector pipelines (62 to 65) execute the processes in the instruction decoding (ID) stage, the register read (RR) stage, the execution (EX) stage, the memory reference (MM) stage and the writeback (WB) stage.

Note that, although, in FIG. 8, the instruction fetch (IF) stage, which has been illustrated with reference to FIG. 1, is omitted and the MM stage is illustrated, various vector processor architectures have been proposed, and, without limiting to FIG. 1 and FIG. 8, various architectures may be employed.

The vector pipelines 60 include pipeline registers 601, 602, 604 and 605, and a parallel operator 603. As illustrated with reference to FIG. 2, for example, the parallel operator 603 operates eight 16-bit operators in parallel and executes parallel operations.

As illustrated in FIG. 8, in the ID stage, instructions are input in the instruction decoder 5 and decoded, and the decoded instructions are loaded in the vector pipelines (pipeline register 601) one instruction after another. Note that, as described above, the number of data to operate by each instruction is managed by the vector length (VL).

In the RR stage, data from the vector register 3 and the mask register 4 is received in the pipeline register 602 and output to the parallel operator 603. In addition, in the EX stage, parallel operations are executed by the parallel operator 603, and the calculation results are output to the pipeline register 604.

Furthermore, in the MM stage, with reference to the memory, the data of the pipeline register 604 is output to the pipeline register 605. Then, in the WB stage, the data of the pipeline register 605 is written back in the vector register 3, and the processing is finished.

FIG. 9 is a block diagram illustrating an example of a mask register in the operation processing device of the present embodiment. As illustrated in FIG. 9, the mask register unit (mask register MR) 4 includes a bit pattern mask storage unit 41, an integer mask storage unit 42, a mode storage unit 43, an integer mask→bit pattern mask converter (converter) 44, an end detection circuit 45, and a counter 46. In addition, the mask register unit 4 includes buffers 47a and 47b and selectors 48a to 48c.

The bit pattern mask storage unit 41, the integer mask storage unit 42 and the mode storage unit 43 have been illustrated with reference to FIG. 7A and FIG. 7B, and the integer mask storage unit 42 and the mode storage unit 43 are newly added to the mask register unit 4 of the present embodiment, as described earlier.

Furthermore, with the mask register unit 4 of the present embodiment, a mode signal (mode) for setting a mode in the mode storage unit 43, and, in the integer mask mode, an end detection signal (end flag) to indicate the end of true data, are used.

In FIG. 9, the reference code read address is a read address signal, write address is a write address signal, data is the data to process, and mask pattern is a mask pattern signal to designate the data to mask.

Note that, for example, the start detection signal (start flag) to designate true data is omitted since the top element that is stored may be detected from the value of the read address signal read address, but may be directly provided, for example, from outside. In addition, a clock signal (clock) and read enable signal (read enable) are obvious and therefore omitted.

With the present embodiment, as has been described with reference to FIG. 7A and FIG. 7B, the mode storage unit 43 is a register of a 1-bit width and eight entries, and, for example, is accessed via addresses (address values divided by 8) given by removing the lower three bits of the read and write address signals read address and write address.

As described above, the setting of the mode storage unit 43 is, for example, the bit pattern mask mode at the time of “0” and the integer mask mode at the time of “1.” Note that the initial value is, for example, “0” (bit pattern mask mode).

The integer mask storage unit 42 is, for example, a register of a 5-bit width and eight entries, and, for example, is accessed via addresses (address values divided by 8) given by removing the lower three bits of the read and write address signals read address and write address. The bit pattern mask storage unit 41 is, for example, a register of an 8-bit width and sixty four entries.

As illustrated in FIG. 9, the buffer 47a and the selector 48a are provided in the output of the mode storage unit 43, and the buffer 47b and the selector 48b are provided in the output of the integer mask storage unit 42.

The buffers 47a and 47b are controlled by the output of the counter 46, and, furthermore, the selectors 48a and 48b each select each input and output of the buffers 47a and 47b and output the input and output to the selector 48c and the converter 44.

The buffer 47a stores, on a temporary basis, the value (mode) read from the mode storage unit 43, and the buffer 47b stores, on a temporary basis, the value read from the integer mask storage unit 42. Then, by means of the selectors 48a and 48b, in the top cycle of each instruction, data that is read is output as is, and saved, for example, in inner flip-flops (buffers 47a and 47b), and, in cycles other than the top cycle, the values stored in the flip-flops are output.

Note that the selector 48c selects the output of the bit pattern mask storage unit 41 or the output of the converter 44, according to the output of the selector 48a, and outputs the selected output as a mask pattern signal mask pattern.

In other words, even in the integer mask mode, the mask pattern signal mask pattern that is output from the mask register 4 is converted into bit pattern mask data and output, in the same way as when the bit pattern mask mode is employed. By this means, the user (programmer) is allowed the same use as a normal vector processor, without caring about the integer mask mode and the bit pattern mask mode.

Among the operation instructions, there are ones that allow instructions to continue, and, by actively applying the integer mask mode to such instructions, it is possible to reduce unnecessary operations and improve the efficiency of operations of the processor.

Consequently, based on the content of operation instructions, it is possible to decide whether or not the integer mask mode is applicable, and, when the integer mask mode is applicable, it is possible to perform vector processing efficiently by generating mask register information in the integer mask mode.

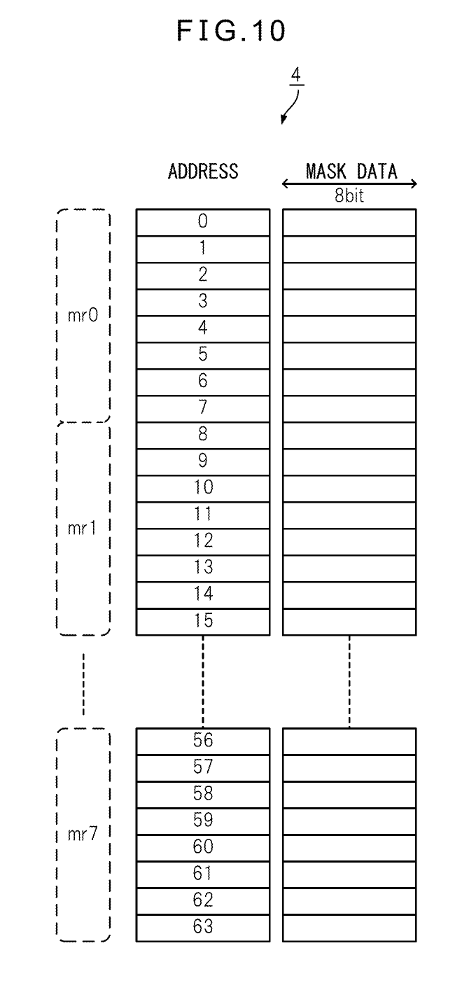

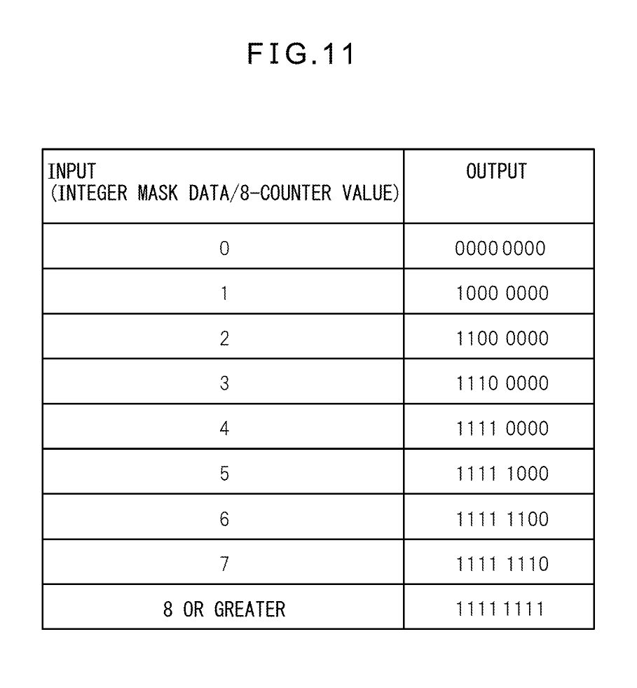

FIG. 10 is a diagram for illustrating the addresses and data arrangement in the mask register of FIG. 9, and FIG. 11 is a diagram for illustrating the processing of a converter in the mask register of FIG. 9.

In the data arrangement of the mask register (MR) 4 illustrated in FIG. 10, the reference codes mr0 to mr7 indicate the operands designated by instruction codes, and, for example, when VL=64, in mr0, data is stored in all entries from addresses=0 to 7.

Furthermore, for example, when VL=32, mr0 uses the entries from addresses=0 to 3, and does not use addresses=4 to 7. Similar to mr0, the entries of mr0 to mr7 are assigned every eight addresses.

Note that, depending on the specifications of the vector processor, when the VL changes, the top position may change (for example, the top position may be moved in the proportion of reduced data), but this only makes the calculations complex, and, when there is information about the architecture, it is possible to detect the top access.

The counter 46 is a counter to perform the following operations.

Initial value=0

(address%8)==at 0: reset (indicating the top of an instruction) (address%8)!=at 0: count up

At the time of the integer mask mode, the end detection circuit 45 is a circuit to detect that the operations of the subsequent cycles are all false (masked). For example, when the following conditions are met, the operations of the next and subsequent cycles are all false (masked), and therefore a signal to indicate that it is possible to cancel the subsequent operations is output to the operation pipeline control circuit.

When the integer mask data is a multiple of 8:

(mode==1) && (((integer mask data/8)−counter value)==1)

When the integer mask data is not a multiple of 8:

(mode==1) && (((integer mask data/8)−counter value)==0)

Note that the pipeline control circuit having received the above signal from the end detection circuit 45 releases the operation slots to enter the state where the next operation may be loaded.

The converter (integer mask→bit pattern mask converter) 44 performs conversion processing to realize the conversion table illustrated in FIG. 11. In other words, when the input of the converter 44 (in other words, the output of the counter 46 of integer mask data/8-counter value) is “0,” “0000 0000” is output, when the input of the converter 44 is “1,” “1000 0000” is output, and, when the input of the converter 44 is “2,” “1100 0000” is output.

Furthermore, when the input of the converter 44 is “3,” “1110 0000” is output, when the input of the converter 44 is “4,” “1111 0000” is output, when the input of the converter 44 input is “5,” “1111 1000” is output, and, when the input of the converter 44 is “6,” “1111 1100” is output.

In addition, when the input of the converter 44 is “7,” “1111 1110” is output, and, when the input of the converter is “8 or greater,” “1111 1111” is output. In this way, it is possible to convert the integer mask pattern data in the integer mask mode into bit pattern mask data and output the bit pattern mask data.

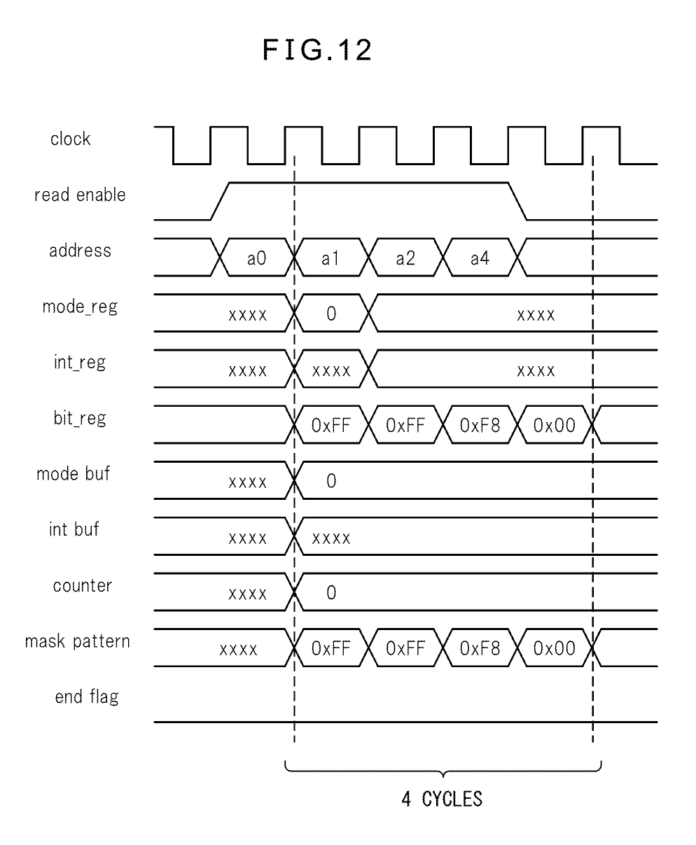

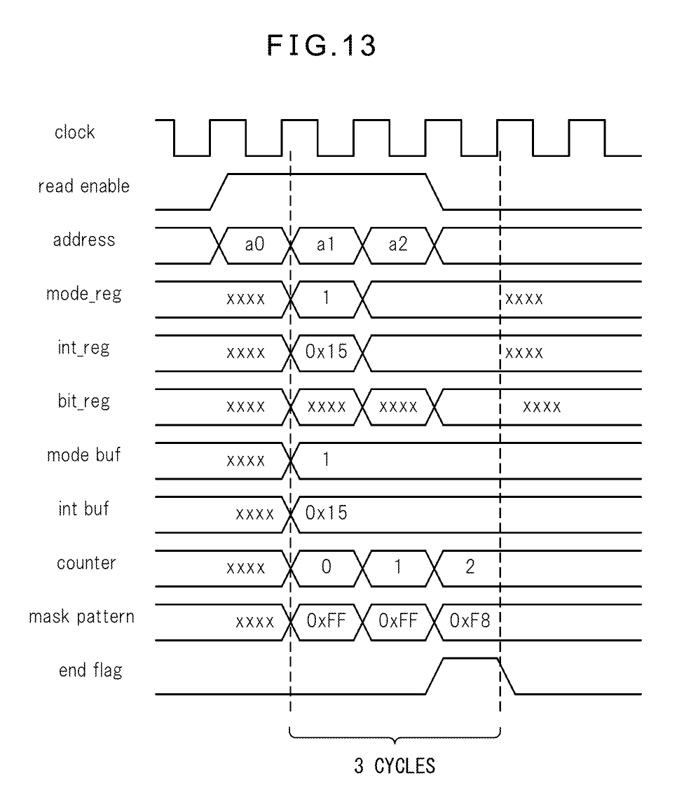

FIG. 12 is a timing chart for illustrating an example of the operations in the bit pattern mask mode in the operation processing device of the present embodiment, and FIG. 13 is a timing chart for illustrating an example of the operations in the integer mask mode in the operation processing device of the present embodiment. Note that FIG. 12 and FIG. 13 illustrate operations at VL=32.

First, when a value that is read from the mode storage unit 43 indicates the bit pattern mask mode (mode reg: “0”), in the mask register 4, bit pattern mask data (bit reg) to correspond to each data is stored in the bit pattern mask storage unit 41. To be more specific, the bit pattern mask data bit reg is “0xFF,” “0xFF,” “0xF8” and “0x00.” In this case, the bit pattern mask data is read from the bit pattern mask storage unit 41, and is output as the value of the mask register 4 (mask pattern signal mask pattern).

In other words, as illustrated in FIG. 12, at VL=32, eight parallel operators are provided, so that one vector instruction takes four cycles. In other words, in the bit pattern mask mode operations, the end detection signal (end flag) is not used, and the mask pattern signal mask pattern is output for four cycles.

By contrast with this, when a value that is read from the mode storage unit 43 indicates the integer mask mode (mode reg: “1”), in the mask register 4, the value to represent the number of true data from the top is stored in the integer mask storage unit 42 as the integer mask data (int reg). In this case, the integer mask data “0x15” is read from the integer mask storage unit 42, and is converted into bit pattern mask data by the converter 44 and output as the mask pattern signal mask pattern.

In other words, as illustrated in FIG. 13, at VL=32, eight parallel operators are provided, so that one vector instruction takes four cycles. However, in the integer mask mode, in the fourth cycle, the eight parallel operations are all false (F), so that the instructions are finished in the third cycle. To be more specific, the end detection signal end flag is output from the end detection circuit 45, and, in response to this, the mask pattern signal mask pattern is output for three cycles and the instructions are finished in the third cycle.

Consequently, as obvious from the comparison of FIG. 12 and FIG. 13, by applying the integer mask mode in the operation processing device of the present embodiment, it is clear that the processing may be performed in time that is one cycle shorter.

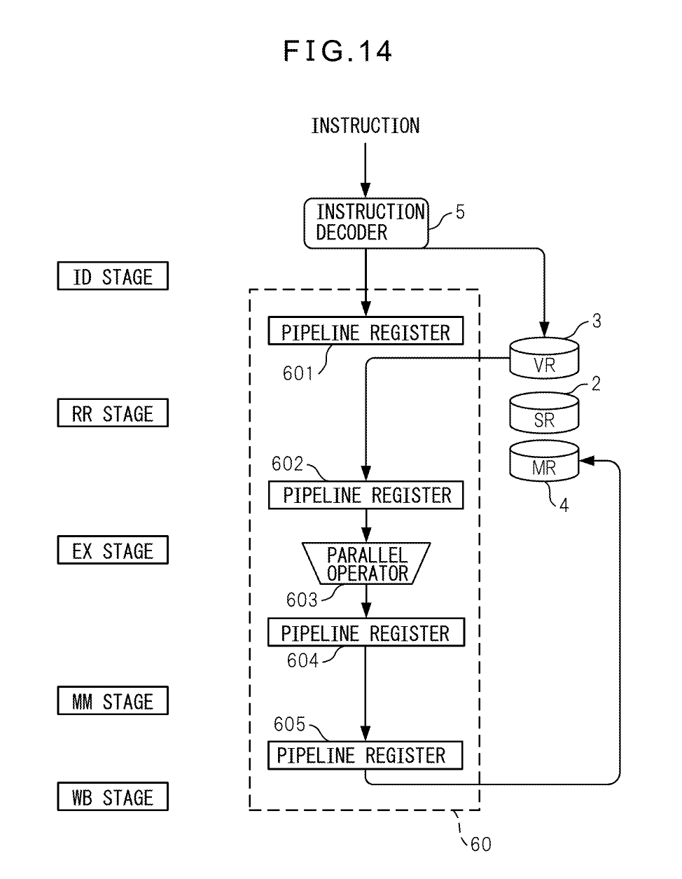

FIG. 14 is a diagram for illustrating mask register writing by a vector instruction in the operation processing device of the present embodiment, and FIG. 15 is a diagram for illustrating mask register writing by a scalar instruction in the operation processing device of the present embodiment.

As has been described with reference to FIG. 8, the vector pipelines 60 (62 to 65) illustrated in FIG. 14 include the pipeline registers 601, 602, 604 and 605, and the parallel operator 603.

Furthermore, the scalar pipeline 61 illustrated in FIG. 15 includes the pipeline registers 611, 612, 614 and 615, and the scalar operator 613.

Note that, as has been described with reference to FIG. 8, the vector pipelines 60 and scalar pipeline 61 execute the processes of the instruction decoding (ID) stage, the register read (RR) stage, the execution (EX) stage, the memory reference (MM) stage and the writeback (WB) stage.

However, in the mask register writing by a vector instruction illustrated in FIG. 14, in the RR stage, data from the vector register 3 is received in the pipeline register 602 and output to the parallel operator 603.

Furthermore, in the mask register writing by a scalar instruction illustrated in FIG. 15, in the RR stage, data from the scalar register 2 is received in the pipeline register 612 and output to the scalar operator 613.

As illustrated in FIG. 14, when an instruction (instruction to compare the VRs, a load instruction to the MR, etc) to make the mask register MR the destination is given in a vector instruction, the writing is executed by placing the MR in the bit pattern mask mode. In other words, the value of the mode storage unit 43 is set to “0,” and the bit pattern mask data is written in the bit pattern mask storage unit 41.

Furthermore, as illustrated in FIG. 15, when an instruction to make the mask register MR the destination is given in a scalar instruction, the writing is executed by placing the MR in the integer mask mode. In other words, the value of the mode storage unit 43 is set to “1,” and the integer mask data is written in the integer mask storage unit 42.

An example of an instruction to write in the mask register (MR) 4 by a scalar instruction will be illustrated below.

ssetim mr0 #10 (instruction to write the immediate value 10 in mr0 in the integer mask mode)

smovrm mr0 sr1 (instruction to write the content of SR1 in mr0 in the integer mask mode)

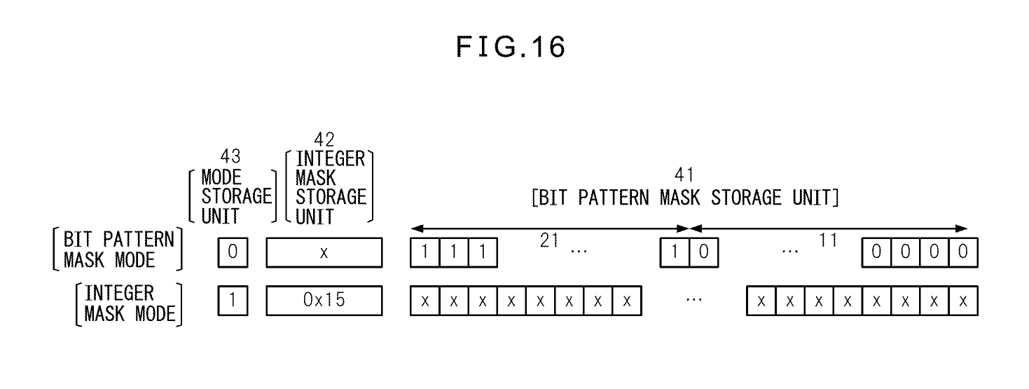

FIG. 16 is a diagram illustrating an example of data entries in the bit pattern mask mode and the integer mask mode. The example of FIG. 16 represents a case where VL=32 and where twenty one pieces of data (elements) from the top are true (T) and the subsequent eleven pieces of data are all false (F). Note that the integer mask data to be set in the integer mask storage unit 42 is represented in hexadecimal.

First, in the bit pattern mask mode where the value of the mode storage unit 43 is “0,” the bit pattern mask storage unit 41 stores a bit pattern in which the first twenty one bits are “1, 1, . . . , 1” and the subsequent eleventh bits are “0, 0, . . . , 0.” Note that the arbitrary value (x) may be used in the integer mask storage unit 42.

Next, in the integer mask mode in which the value of the mode storage unit 43 is “1,” the integer value “0x15” is stored in the integer mask storage unit 42. “0x15” that is set in the integer mask storage unit 42 is hexadecimal, indicating that the first twenty one pieces of data from the top are true and the twenty second and subsequent pieces of data are false.

In other words, when the value of the mode storage unit 43 is “1” and the value of the integer mask storage unit 42 is “0x15,” it is understood that twenty one pieces of data from the top are true and the twenty second and subsequent pieces of data are false. Consequently, by finishing the operations (instructions) to correspond to the twenty second and subsequent pieces of data at this point in time and loading the next instruction, it is possible to execute the processing efficiently.

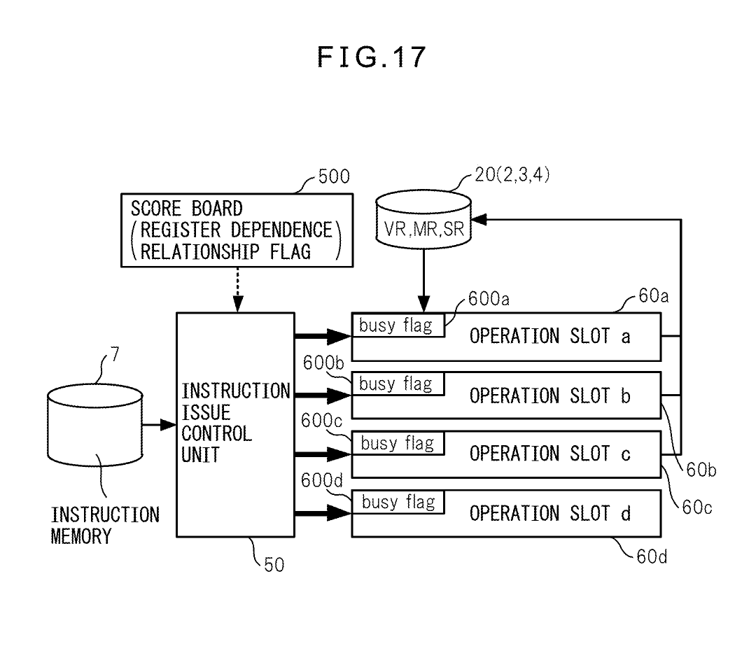

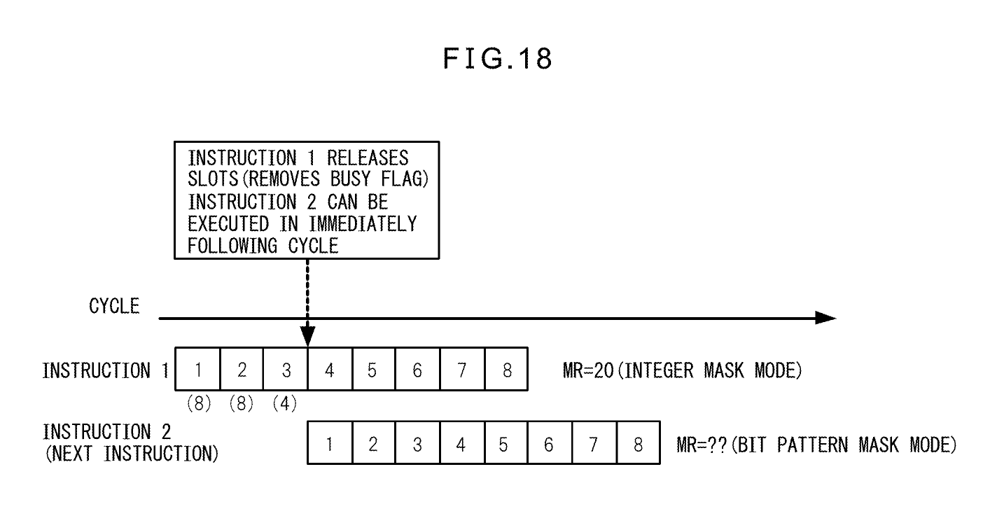

FIG. 17 and FIG. 18 are diagrams for illustrating instruction issue control in the operation processing device of the present embodiment. The instruction issue control unit 50 corresponds to the instruction decoder 5 in FIG. 4 described above, and the operation slots 60a to 60d correspond to the vector pipelines 62 to 65 in FIG. 4. Furthermore, the operation slots 60a to 60d each include eight operators, and, by processing the eight operators over eight cycles, execute the operation instructions of VL=64.

As described above, in the integer mask mode, depending on the value stored in the integer mask storage unit 42, it is possible to check the number of data (for example, twenty one) to be true from the top, and the subsequent (twenty second and subsequent) data (twenty second to sixty-fourth pieces of data). Then, the instruction to correspond to the false twenty second and subsequent pieces of data is cancelled, and the next instruction is issued.

In other words, as illustrated in FIG. 17, instructions that are read from the instruction memory 7 are loaded in the operation slots 60a to 60d (vector pipelines 62 to 65) via the instruction issue control unit 50 (instruction decoder 5). A busy flag is provided in each of the operation slots 60a to 60d.

The instruction issue control unit 50 issues an instruction by watching the dependence relationships between the registers and the state of use of operation slots. For example, when the operation slots 60a to 60d each include eight operators, when one instruction is issued, the operations slots are occupied during VL/8 cycles.

In the integer mask mode, depending on the value stored in the integer mask storage unit 42 (MR=20), it is learned that the subsequent data is false, from the number of data (twenty) that is true, so that it is possible to cancel the instruction that is being executed in the middle and load the next instruction in the operation slots.

To be more specific, as illustrated in FIG. 18, in the integer mask mode, given that MR=20 is 20=8+8+4, although the processing is performed using eight operators in the first and second cycles, in the third cycle, the processing may be performed using four operators.

Then, since false operations are performed in the fourth cycle and onward, the instruction (instruction 1) up till then is cancelled in the third cycle, i.e. the operation slots are released (by removing the busy flag), and, from the fourth cycle, the next instruction (instruction 2) is loaded and executed. By this means, it is possible to shorten the period in which the operation slots are busy, and start the next instruction early.

In addition, with the present embodiment, since integer mask data is stored in the integer mask storage unit 42, even when the VL is long, setting is possible in one cycle.

In other words, among the operation instructions, there are ones that allow instructions to continue, and, by actively applying the integer mask mode to such instructions, it is possible to reduce unnecessary operations and improve the efficiency of operations of the processor.

Consequently, based on the content of operation instructions, it is possible to decide whether or not the integer mask mode is applicable, and, when the integer mask mode is applicable, it is possible to perform vector processing efficiently by generating mask register information in the integer mask mode.

FIG. 19A and FIG. 19B are each a diagram for illustrating another implementation example of the operation processing device of the present embodiment, where FIG. 19A illustrates the configuration of the register and FIG. 19B illustrates an example of the bit pattern mask mode and the integer mask mode.

As clear from the comparison between FIG. 19A and above-described FIG. 7A, with the present implementation example, only the mode storage unit 43 of a 1-bit width is added, and a register entry of a general vector processor is used also as the integer mask storage unit 42.

In other words, with the present implementation example, part of the bit pattern mask storage unit 41 is shared, without adding a register to use as the integer mask storage unit 42. For example, upon storing the integer mask data, the integer mask data is stored in the position of the top address of each operand in the bit pattern mask storage unit 41.

In this way, when a register entry of the vector processor is shared without newly adding a register for the integer mask storage unit 42, although it is possible to reduce the increase of the register capacity, for example, there is a threat to cause a problem with the chaining with the subsequent instructions. In this case, for example, it is possible to support by providing a buffer to save data, for chaining with the subsequent instructions.

FIG. 19B corresponds to FIG. 7B described earlier, and is the same except that a register entry of the vector processor is shared as the integer mask storage unit 42.

In other words, in MR0 in which the value of the mode storage unit 43 is “0” and which is in the bit pattern mask mode, a bit pattern in which the first three bits are “1, 1, 1,” and all the subsequent bits are “0, 0, . . . , 0,” is stored in the bit pattern mask storage unit 41. Note that, in the bit pattern mask mode, the value of the integer mask storage unit 42 may be an arbitrary value (x).

Next, in MR1 in which the value of the mode storage unit 43 is “1” and which is in the integer mask mode, the integer value “3” is stored in the integer mask storage unit 42. Note that, in the integer mask mode, all the bits in the bit pattern mask storage unit 41 may be arbitrary values (x).

When the user (programmer) uses a debugger, it is possible to allow the user not to be conscious of the mask mode, by providing the debugger with the function of displaying data given by converting the integer mask mode into the bit pattern mask mode and displaying the converted data. In other words, on the debugger screen, at the time of the integer mask mode, the integer mask data is converted into the bit pattern mask data and displayed.

Then, when the user changes the value of the MR on the debugger screen—for example, when “1” continues at the top and the value “0” is set in the rest, the integer mask data is written in the operation processing device (mask register unit) automatically as the integer mask mode. By this means, the user is able to perform the debugging processing without being conscious of the integer mask mode and the bit pattern mask mode.

It is furthermore possible to use one of integer mask mode and the bit pattern mask mode by new instructions to set mask data in both the integer mask mode and the bit pattern mask mode and set values in the mode storage unit 43.

In other words, in the above illustration, when integer mask data is written in the integer mask storage unit 42, “1” is stored in the mode storage unit 43, and, when the integer mask mode is employed, the integer mask data of the integer mask storage unit 42 is read.

Furthermore, when bit pattern mask data is written in the bit pattern mask storage unit 41, “0” is stored in the mode storage unit 43, and, when the bit pattern mask is employed, the bit pattern mask data of the bit pattern mask storage unit 41 is read.

By contrast with this, with respect to all data, bit pattern mask data is written in the bit pattern mask storage unit 41, and furthermore integer mask data is written in the integer mask storage unit 42.

Then, by a new instruction to set the value of the mode storage unit 43 to “0” or “1,” it is possible to use one of the bit pattern mask data and the integer mask data. In other words, by changing the value of the mode storage unit 43 by a new instruction, it is possible to make effective use of each entry of the bit pattern mask storage unit 41 and the integer mask storage unit 42.

Note that, in the above, in the bit pattern mask mode, bits to indicate true/false are assigned to all data, so that true data (operations) may not necessarily continue. Furthermore, in the integer mask mode, the number of data (operations) to be true continuously, and stored in the integer mask storage unit 42, is not necessarily limited to data that continues being true from the top, as will be described with reference to next FIG. 20.

FIG. 20 is a diagram for illustrating a modification example of setting of integer mask data in the operation processing device of the present embodiment, illustrating an example where, in the integer mask mode, the number of continuous data that is true does not start from the top.

In the integer mask mode, for example, the number of data to be false (F) from the top is designated by the control register (51), and, by the value set in the integer mask storage unit 42, the number of continuous data to be true (T) subsequently is designated. Note that the control register (51) is, for example, illustrated in FIG. 4.

To be more specific, as illustrated in FIG. 20, the number of data, four, to be false from the top is designated by the control register, and, later, the number of continuous data, five, to be true is designated by the integer mask storage unit 42. In other words, the control register designates the starting position of continuous data that is true.

The five continuous pieces of data that are designated by the integer mask storage unit 42 and that are true, are five pieces of data from the fifth piece of data in the first cycle to the first piece of data in the second cycle, so that, in the second cycle, the instruction up till then is cancelled (finished). Then, from the third cycle, the next instruction is executed.

Note that, as illustrated in FIG. 20, in the integer mask mode, when the number of continuous data that is true does not start from the top, with reference to FIG. 9 and FIG. 11, the above-described end detection circuit 45 and converter 44 may be changed.

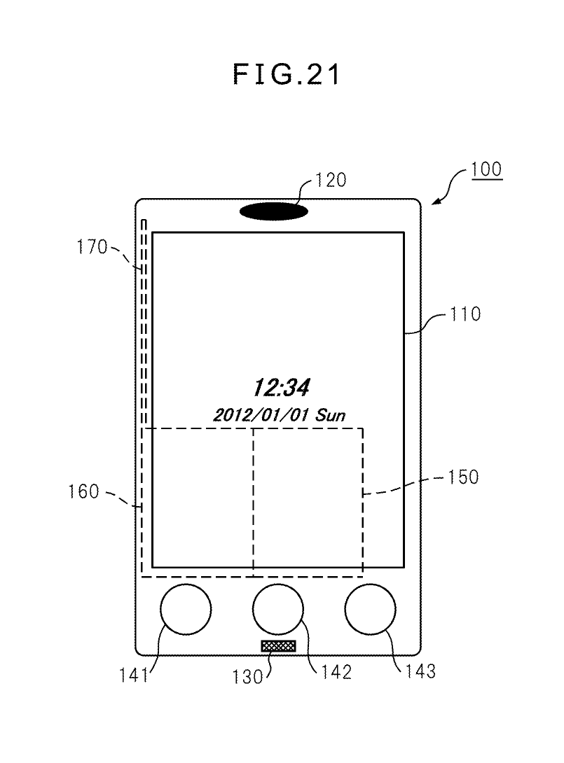

FIG. 21 is a diagram schematically illustrating an example of the mobile terminal of the present embodiment and illustrating an example of a mobile terminal supporting software-defined radio. As illustrated in FIG. 21, the mobile terminal 100 includes a display 110, a speaker 120, a microphone 130, operation keys 141 to 143, a baseband processing unit 150, a high frequency (Radio Frequency: RF) circuit 160, and an antenna 170.

The display 110 is a touch panel, and, obviously, includes various processing circuits, memories and so on, in addition to the baseband processing unit 150, as circuits.

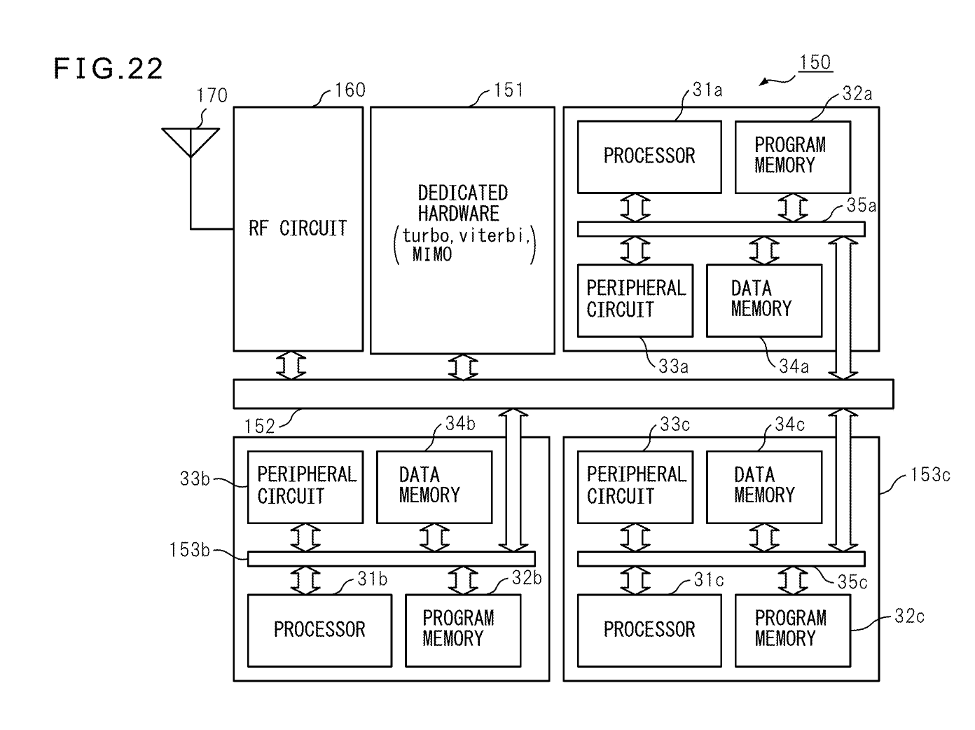

FIG. 22 is a block diagram illustrating an example of a baseband processing unit in the mobile terminal of the present embodiment. As illustrated in FIG. 22, the baseband processing unit 150 includes dedicated hardware 151, bus (connecting wire) 152, and a plurality of modules 153a to 153c.

The dedicated hardware 151 includes dedicated hardware to support, for example, turbo, viterbi and multi-use (MIMO: Multi Input Multi Output) and so on.

The dedicated hardware 151 is designed such that change of setting is possible to a certain degree, with respect to parameters that support heavy processing, and the dedicated hardware 151 and the modules 153a to 153c are connected to the RF circuit 160 via the bus 152. Note that the dedicated hardware 151 and RF circuit 160 and so on are connected via analog interfaces.

The modules 153a to 153c include, respectively, processors (vector processors: operation processing devices) 31a to 31c, program memories 32a to 32c, peripheral circuits 33a to 33c and data memories 34a to 34c.

In the modules 153a to 153c, the processors 31a to 31c, the program memories 32a to 32c, the peripheral circuits 33a to 33c and the data memories 34a to 34c are all connected via internal buses 35a to 35c.

The modules 153a to 153c are able to support mutually varying wireless standards (for example, W-CDMA, LTE and/or the like) by means of the processors 31a to 31c, the program memories 32a to 32c, the peripheral circuits 33a to 33c and the data memories 34a to 34c.

Then, via the RF circuit 160 and the antenna 170, wireless communication is performed according to the wireless standards set by the modules 153a to 153c.

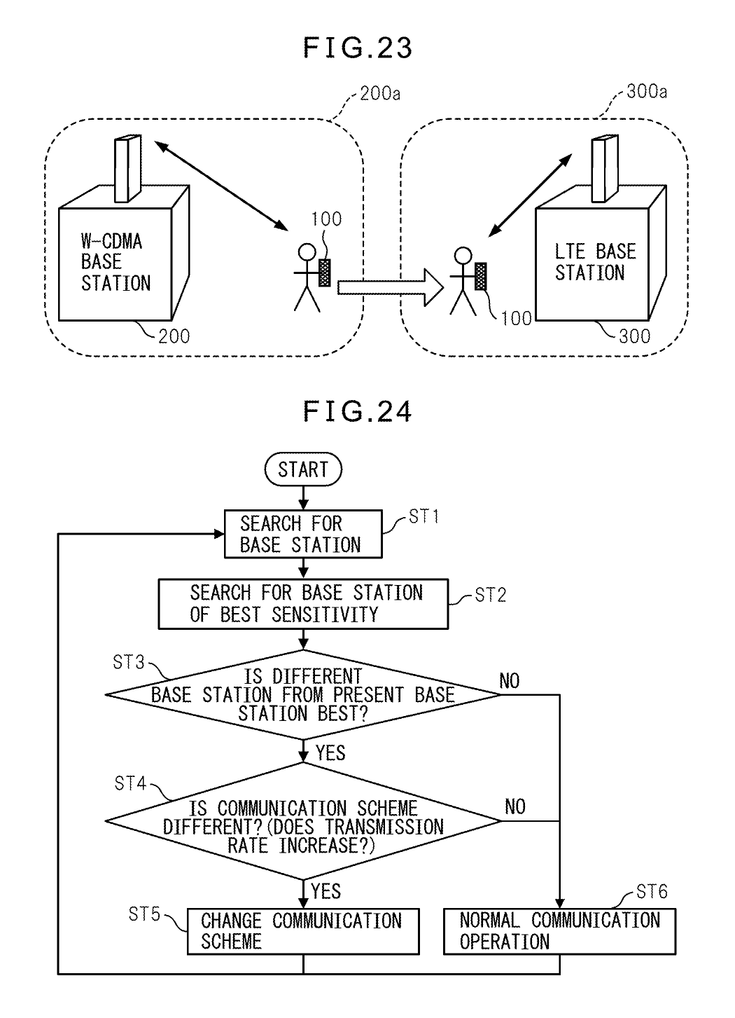

FIG. 23 is a diagram for illustrating an example of software-defined radio functions to perform communication by switching between different communication schemes by the mobile terminal of the present embodiment.

In FIG. 23, the reference code 200 indicates a base station of the W-CDMA (Wideband Code Division Multiple Access) scheme, and 200a is the radio coverage area of the W-CDMA base station 200. Furthermore, the reference code 300 indicates a base station of the LTE (Long Term Evolution) scheme, and 300a indicates the radio coverage area of the LTE base station 300.

As illustrated in FIG. 23, for example, when the user carrying the mobile terminal 100 leaves the radio coverage area 200a of the W-CDMA base station 200 and enters the radio coverage area 300a of the LTE base station 300, the mobile terminal 100 communicates by switching the base station from 200 to 300.

To be more specific, the module 153a in FIG. 22 is used to realize communication of the W-CDMA scheme, and the module 153b in FIG. 22 is used to realize communication of the LTE scheme. Consequently, when the radio coverage area changes from 200a to 300a, the module to be used for communication in the mobile terminal 100 switches from 153a to 153b.

The modules 153a and 153b perform vector operations to perform communication in the W-CDMA and LTE schemes. Note that the mobile terminal 100 having software functions is not limited to the W-CDMA and LTE schemes and may use various communication schemes.

FIG. 24 is a flowchart illustrating an example of processing to realize the software-defined radio functions of FIG. 23.

First, when the processing to realize the software-defined radio functions start, in step ST1, the base station is searched for, and the step moves on to step ST2. In step ST2, the base station of the best sensitivity is searched for, and furthermore, moving on to step ST3, whether or not a different base station from the present base station is the best is decided.

In step ST3, when a different base station from the present base station is decided to be the best (have the best sensitivity), the step moves on to step ST4, and whether or not the communication scheme is different (whether or not the transmission rate increases) is decided. In step ST4, when the communication scheme is decided to be different, the step moves on to step ST5, the communication scheme is changed, and, back to step ST1, the same processing is repeated.

As for the change of the communication scheme, the module 153a of the W-CDMA scheme is switched to the module 153b of the LTE scheme, and, furthermore, the setting of the parameters of the dedicated hardware 151 is changed, and the W-CDMA scheme is switched to the LTE scheme.

On the other hand, in step ST3, when a different base station from the present base station is not decided to be the best—i.e. when the present base station is decided to be good, or, when, in step ST4, the communication scheme is not decided to be different—i.e. when the communication scheme is decided to be the same communication scheme up till then, the step moves on to step ST6. In step ST6, normal communication operations are repeated—i.e. the communication scheme is not changed, and, back to step ST1, the same processing is repeated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An operation processing device for executing a plurality of operations for aligned data by one vector instruction, the operation processing device comprising:
a first mask storage unit which stores first mask data to designate each of the plurality of operations a true or false operation; and
a second mask storage unit which stores second mask data to designate a number to be true continuously, in the plurality of operations.

2. The operation processing device as claimed in claim 1, wherein, when the second mask data is used, after the number of operations to be true continuously, designated by the second mask data, are executed, a vector instruction that is being executed is cancelled, without executing subsequent false operations.

3. The operation processing device as claimed in claim 2, wherein, when the second mask data is used, after the vector instruction that is being executed is cancelled without executing the false operations, an operation slot is released and a different instruction from the vector instruction that is being executed is executed.

4. The operation processing device as claimed in claim 1, wherein the second mask storage unit stores the number of operations to be true continuously from the top, in a vector length of the vector instruction.

5. The operation processing device as claimed in claim 1, wherein
for the plurality of operations, the first mask data is stored in the first mask storage unit and the second mask data is stored in the second mask storage unit, and
the first mask data or the second mask data is selected and used.

6. The operation processing device as claimed in claim 1, the operation processing device further comprising a mode storage unit which stores a first mask mode to use the first mask data or a second mask mode to use the second mask data.

7. The operation processing device as claimed in claim 6, the operation processing device further comprising:
a converter which converts the second mask data into data of a same format as the first mask data; and
a selector which selects the first mask data stored in the first mask storage unit when the first mask mode is stored in the mode storage unit, and selects the data of the same format as the first mask data, converted by the converter, when the second mask mode is stored in the mode storage unit.

8. The operation processing device as claimed in claim 6, the operation processing device further comprising an end detection circuit which detects an end of the number to be true continuously, from the second mask data, when the second mask mode is stored in the mode storage unit.

9. The operation processing device as claimed in claim 1, wherein
the operation processing device comprises:
at least one scalar pipeline; and
at least one vector pipeline, and
the vector pipeline comprises a plurality of operators which operate in parallel.

10. The operation processing device as claimed in claim 9, wherein
the first mask data is written in the first mask storage unit by a vector instruction and
the second mask data is written in the second mask storage unit by a scalar instruction.

11. A mobile terminal comprising a baseband processing unit which performs communication by a plurality of wireless communication schemes including first and second wireless communication schemes, wherein
the baseband processing unit comprises:
a first module for performing communication by the first wireless communication scheme;
a second module for performing communication by the second wireless communication scheme; and
dedicated hardware, setting of which is changed by a parameter, and
each of the first module and the second module comprises an operation processing device for executing a plurality of operations for aligned data by one vector instruction, wherein
the operation processing device comprises:
a first mask storage unit which stores first mask data to designate each of the plurality of operations a true or false operation; and
a second mask storage unit which stores second mask data to designate a number to be true continuously, in the plurality of operations.

12. The mobile terminal as claimed in claim 11, wherein the first module and the second module are selected according to sensitivity from a first base station of the first wireless communication scheme and a second base station of the second wireless communication scheme.

13. The mobile terminal as claimed in claim 10, wherein the first module and the second module each further comprise a program memory, a data memory and a peripheral circuit that are connected with the operation processing device.

14. An operation processing method for executing a plurality of operations for aligned data by one vector instruction, the operation processing method comprising:
setting first mask data to designate each of the plurality of operations a true or false operation;
setting second mask data to designate a number to be true continuously, in the plurality of operations;
setting a first mask mode to use the first mask data or a second mask mode to use the second mask data; and
when the second mask mode is set, after the number of operations to be true continuously, designated by the second mask data, are executed, a vector instruction that is being executed is cancelled, without executing subsequent false operations.

15. The operation processing method as claimed in claim 14, the operation processing method further comprising, after the vector instruction that is being executed is cancelled without executing the false operations, releasing an operation slot and executing a different instruction from the vector instruction that is being executed.
